(19) United States
(12) Patent Application Publication
(10) Pub. No.: US 2008/0313483 A1
(43) Pub. Date: Dec. 18, 2008

(54) Method and System for Power Management

(76) Inventor: Ravikiran Pasupuleti Sureshbabu, Chennai (IN)

Correspondence Address: ALIX YALE & RISTAS LLP, 750 MAIN STREET, SUITE 1400, HARTFORD, CT, 06103, US

(21) Appl. No.: 11/883,396

(22) PCT Filed: Jan. 30, 2006
(86) PCT No.: PCT/IN06/00030

§ 371 Date: Jul. 31, 2007

(30) Foreign Application Priority Data
Feb. 1, 2005 (IN) 81/CHE/2005

(51) Int. Cl. G06F 1/28; G06F 1/26

(52) U.S. Cl. 713/330

(57) ABSTRACT

The present invention relates to power management and, in particular, to a method and system for power management of computers and other mobile devices. The power management of the invention would enable meeting the present day demands of effective power management in smaller and cheaper computing devices including mobile computing devices such as palm top computers, smart phones, note book computers and the like. Importantly, the power management of the invention is directed to managing power resources and power states of power manageable computing system and peripheral devices/gadgets for its more efficient and cost effective application/use.

### FIELD OF THE INVENTION

The present invention relates to power management and, in particular, to a method and system for power management of computers and other mobile devices. The Power management of the invention avoids the complexities of power Management schemes involving operative system or hardware system specific provisions. The power management of the invention would enable meeting the present day demands of effective power management in smaller and cheaper computing devices including mobile computing devices such as palm top computers, smart phones, note book computers and the like. Importantly, the power management of the invention is directed to managing power resources and power states of power manageable computing system and peripheral devices/gadgets for its more efficient and cost effective application/use.

### BACKGROUND ART

It is well-known that computers and the mobile devices and their peripheral gadgets require power resource for effective functioning and operation. However, considering the multiple applications based operative units/hardware involved in such computing devices and peripherals gadgets, the requirement of power in such sub-system of a computing unit or a mobile device varies based on the activity or desired application of such sub-system by the user. Thus when a particular sub-system is not required to operate or deliver based on application instruction of the user, the unit requirement for power is less as compared to situation when the specific sub-system needs to function and deliver the application specific output.

Moreover, considering that all such computing devices and mobile devices essentially work on power sources it is important that the available resource of power supplying to such computing devices/gadgets have the required optimized supply of power for continued and efficient application/use of the computing unit or device.

It is well-known to provide power management scheme for such computer and other mobile devices which are either operating system or hardware system specific. In particular, it is experienced that it is inconvenient and inefficient to develop, deliver and maintain system specific application and utilities. Technological advancement has led to smaller and cheaper computing devices wherein power management is a critical feature in the design of such devices.

Power management is also found to be important issue in mobile computing devices which includes notebook computer, palm top computer, network computer, personal digital assistants, embedded devices, smart phones and other computing devices which are presently available or which may be developed in the future. It is therefore, extremely important and desirable to provide a power management method and system that would overcome problems encountered in conventional power management systems both in computing and mobile computing devices and will operate on plurality of hardware platform and operating system.

### OBJECTS OF THE INVENTION

It is thus the basic object of the present invention to provide a method and system for power management of computers and other mobile devices whereby the afore discussed problems of the conventional prior art methods in as far as efficient power management is concerned can be addressed and thereby the performance and efficient use of variety of such computing devices and mobile devices could be achieved.

Another object of the present invention is to develop a method and system for managing the power resources and power states of power manageable computing system and attached devices which would serve to effectively manage the power in such computing devices/system and provide for more user friendly application/uses of such devices.

Yet another further object of the invention is directed to a virtual machine based power management method and system which would provide for application specific management of power in computing devices/system and its peripheral external gadgets of devices.

Yet another object of the present invention is directed to provide a system, which would enable running other application and utilities under optimum power utilization thereby avoiding unwanted wastage in situations of scarce and limited power resources for computing system and its attached devices.

Another object of the present invention is directed to a system of power management which would provide for application development and programming interfaces and device structures to develop deploy and maintain client's application.

A further object of the present invention is directed to the development of a dynamic frequency management method for power management.

Yet further object of the present invention is directed to a system of computing devices and/or its connecting gadgets/devices which would integrate power management methods effectively while executing client's application in order to bring about optimal power consumption in application/user of such computing devices.

A further object of the present invention is directed to a system for power management in computing devices/gadgets which would be capable of handling all power management function wherein the client's application do not have to manage the power but the same will be automatically addressed and taken care of by a virtual machine based power management configuration

### SUMMARY OF THE INVENTION

Thus according to the basic aspect of the present invention there is provided a method for power management of computers and other mobile devices comprising the steps of:

initially bringing the central processing unit (CPU) and all other peripheral devices to an optimal power usage state constituting an most optimal power usage state;
identifying whether the client application is about to execute a CPU intensive operation and, if so, boost the CPU speed using dynamic frequency management;
identifying whether the client application is required to execute any command to activate the peripheral hardware or applications and, if so, boost the power/wake up by throttling up power to the peripheral devices from its optimal power usage state initiating a Power-Up cycle such as to enable executing of the command; and
after the completion of execution of the command initiating a Power-Down cycle whereby the power is throttled down till it reaches the said most optimal power usage state.

In the above method for power management after the boosting the power/wake up of the peripheral hardware or application, the same is adapted to be maintained in the state for a desired wait period before switching to state of the most optimal usage state to facilitate maintaining the overall responsiveness of the system.

Importantly, during the Power-Up cycle the after a predetermined interval of time, the processing power of the CPU is throttled and continued to increase the processing power till a predetermined highest power state is attained; and when the API completes executing the control is transferred back to the caller and the Power-Down Cycle is initiated wherein after a predetermined time interval the power is throttled down till it reaches a optimal power state.

In accordance with another aspect of the present invention there is provided a method for power management comprising building a standardized client profile of the client applications to identify the CPU speed and peripheral requirements such that when the same application is required in a subsequent occasion, the power management is activated accordingly pro-actively based on the standardized client profile without any additional instructions.

In particular in the above method the power management comprises carrying out such power management by communicating with key modules as a virtual machine seamlessly. More preferably, the method comprises communicating with said virtual machine modules using a virtual machine system manager means and with other peripheral devices using a virtual machine hardware abstraction layer such that only when the services of a particular sub-system is required the same is activated and when the services of the sub-system is not required it is restored to an idle/sleep state. The method is adapted to monitor the processor usage requirement and throttling the processor speed accordingly.

More particularly, the above method involves managing power using a concurrent state machine adapted to run independently of the main threads of the application such that when an application issues calls to an API, the state machine starts the power-up cycle and after a predefined interval the processing power of the CPU is throttled to move to a first state and subsequently the processing power is throttled further up as long as the API is executing till the virtual machine reaches the highest power state and when the API completes executing the control it is transferred back to the caller and a power down cycle is initiated. In said power down cycle after a predefined interval the power is throttled down till it reaches the optimal power state. When a new API is called during the power down cycle the power down cycle is suspended and the power up cycle is started from the last power down cycle.

In accordance with another aspect of the invention there is provided a system for power management of computers and other mobile devices comprising:

means to initially bringing the central processing unit and all other peripheral devices to an optimal power usage state constituting an idle state;
means to identify whether the client application is about to execute a CPU intensive operation and, if so, adapted to boost the CPU speed using dynamic frequency management;
means to ascertain whether the client application is required to execute any command to activate the peripheral hardware or applications and, if so, means to power/wake up the peripheral devices from its idle state such as to enable executing of the command; and
means adapted such that after the completion of execution of the command initiating a Power-Down cycle whereby the power is throttled down till it reaches the said most optimal power usage state.

In the above system after the boosting the power/wake up of the peripheral hardware or application the same is adapted to be maintained in the state for a desired wait period before switching to state the most optimal usage state to facilitate maintaining the overall responsiveness of the system.

In accordance with another preferred aspect the system of the invention comprises means adapted to build a standardized client profile of the client applications to identify the CPU speed and peripheral requirements such that when the same application is required to be repeated, the power management is activated accordingly pro actively based on the standardized client profile without any additional instructions.

The system is adapted with communicating means for communicating with key modules as a virtual power management machine seamlessly. In particular, the power management involves means for communicating with said virtual machine modules using a virtual machine system manager means and with other peripheral devices using a virtual machine hardware abstraction layer such that only when the services of a particular sub-system is required the same is activated and when the services of the sub-system is not required it is restored to an idle/sleep state.

The system according to the invention further comprises means adapted for monitoring the processor usage requirement and throttling the processor speed and power supply accordingly.

More particularly, the above power management system of the invention can comprise means for managing power comprising a concurrent state machine means adapted to run independently of the main threads of the application such that when an application issues calls to an API, the state machine means starts the power-up cycle and after a predefined interval the processing power of the CPU is throttled to move to a first state and subsequently the processing power is throttled further up as long as the API is executing till the virtual machine reaches the highest power state and when the API completes executing the control it is transferred back to the caller and a power down cycle is initiated.

In said power down cycle after a predefined interval the power is throttled down till it reaches the optimal power state. The system is adapted with means such that when a new API is called during the power down cycle the power down cycle is suspended and the power up cycle is started from the last power down cycle.

In accordance with an aspect the system for power management of the invention comprises: a power manager unit operatively communicating with said virtual machine system manager, virtual machine modules for said virtual machine applications and also to the peripheral device hardware through a hardware abstraction layer.

More preferably, the above system for power management includes:

said virtual machine system manager include sub-systems selected from Display Manager, File System Manager, I/O manager, Connectivity Manager and Memory Manager;
said virtual machine Modules selectively include VM Browser means, C Basic, RDBMS means and Smart Sync means;
said virtual machine application means selectively include VM objects, Database, BAS, Images and Forms.

It is thus possible by way of the above discussed method and system of power management to provide for the most optimal power usage state at the time of initialization of the system and, thereafter, to speed up the CPU operation by dynamic frequency management and further if required, based on client specific application the system would be adapted to supply power/wake up the peripheral hardware application from the idle mode, i.e. its initial state of operation.

Importantly, when the system boosts the power/wakes up a peripheral hardware of application it does not straight away switch back its initial state but the system is adapted to maintain and adaptive wait period before switching the initial state. This ensures that the latency introduced by power management method do not effect the overall responsiveness.

As also discussed above in accordance with the another aspect of the invention this system is also adapted to build a profile of the client application to identify the CPU Speed and peripheral requirements such that when the same application is executed at a later point of time the system is adapted to pro-actively start managing the power without the need for a specific instruction in the client application for such power management.

The details for the invention, its object and advantages are explained hereunder in greater details in relation to non-limiting exemplary illustration as per the accompanying figures as detailed hereunder:

### BREAK DESCRIPTION OF THE ACCOMPANYING FIGURES

FIG. 1: is a flow diagram illustrating power manager used in the system in accordance with the present invention;

FIG. 2: is a flow diagram illustrating the use of concurrent state machine adapted to run independent of the main threads of the application used by the power manager of the present invention.

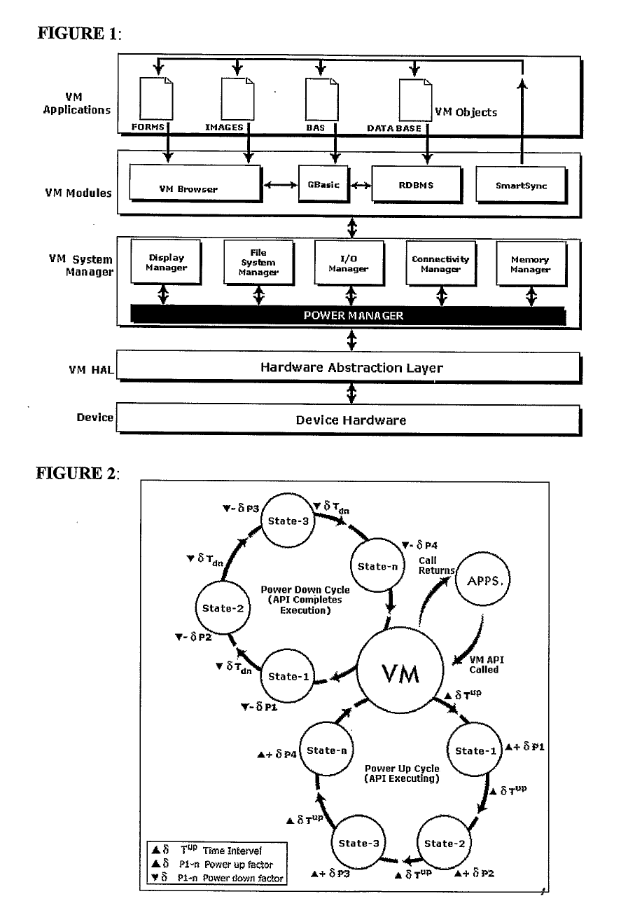

Reference is first invited to FIG. 1 which illustrate the power manager of the invention adapted to communicate with all the key modules of the virtual machine seamlessly. When a service of a particular sub-system is required the power manager is adapted to wake it up so as to utilize its services. When a sub-system is not in use for a pre-defined amount of time, the power manager puts the sub-system to sleep. The power manager also monitors the processor usages requirements and throttles the processor speed accordingly.

Reference is now invited to accompanying FIG. 2 which illustrates how the power manager of the invention is adapted to use a concurrent state machine that would run independent of the main thread of the application. When an application issues calls to an API, the state machine starts the power up cycle. After a pre-determined interval δ-T^{UP}, the power manager starts throttling the processing power of the CPU to the move the virtual machine to State 1. The power manager start throttling the processing power up as long as the API is executing till the virtual machine reaches the highest power state. When the API completes executing, the control is transferred back to the caller and power down cycle is started. In the power down cycle, after a pre-determined interval δ-T^{Down} the power manager is adapted to start throttling power down till it reaches the optimal power state.

In the instance any new API is called during the power down cycle, the power down cycle is suspended and the power up cycle starts from the last power down cycle.

It would be apparent from the above illustrations that when the system is initialize, it is adapted to bring the central processing unit (CPU) and all the peripheral systems to the most optimum power usage state (State 1). The system then identifies whether the client's application is about to execute a CPU intensive operation and boost the CPU speed using dynamic frequency management (state 2). The system is further adapted to peruse the commands in the client's application to identify, if the client application is about to execute a command that requires peripheral hardware or application. Accordingly, the system powers/wakes up the peripheral hardware or application from the idle mode, initializes it and brings it to a state where it can execute the command (State 3).

When the system boosts the power/wakes up a peripheral hardware of application, it does not switch back to state 1 right away. The system maintains an adaptive wake period before switching to state 1. This ensures that the latency introduced by the power management method do not effect the overall responsiveness.

Importantly, the system as discussed about is further adapted to build a profile of the client's application to identify the CPU speed and peripheral requirements such that when the same application is executed the next time the system is adapted to pro-actively start managing the power without the need for a specific instruction in the client's application to initiate the power management system.

It is thus possible by way of the above invention to provide a method and system for power management of computers and other mobile devices whereby the problems of the conventional prior art methods in as far as efficient power management is concerned can be addressed and thereby the performance and efficient use of variety of such computing devices and mobile devices could be achieved. The system would thus serve to effectively manage the power in such computing devices/system and provide for more user friendly application/uses of such devices. Importantly, the virtual machine based power management method and system would provide for the much desired application specific management of power in computing devices/system and its peripheral external gadgets of devices.

1.-22. (canceled)

23. A method for power management of computers and other mobile devices comprising the steps of:
initially bringing the central processing unit (CPU) and all other peripheral devices to an optimal power usage state constituting a most optimal power usage state;
identifying whether the client application is about to execute a CPU intensive operation and if so, boost the CPU speed using dynamic frequency management;
identifying whether the client application is required to execute any command to activate the peripheral hardware or applications and, if so, boost the power/wake up by throttling up power to the peripheral devices from its optimal power usage state initiating a Power-Up cycle such as to enable executing of the command;
after the completion of execution of the command initiating a Power-Down cycle whereby the power is throttled down till it reaches the said most optimal power usage state; and
carrying out such power management by communicating with key modules as a virtual machine seamlessly.

24. A method for power management according to claim 23 wherein after the boosting the power/wake up of the peripheral hardware or application, the same is adapted to be maintained in the state for a desired wait period before switching to state of the most optimal usage state to facilitate maintaining the overall responsiveness of the system.

25. A method for power management according to claim 23 wherein during the Power-Up cycle the after a predetermined interval of time, the processing power of the CPU is throttled and continued to increase the processing power till a predetermined highest power state is attained; and
when the API completes executing the control is transferred back to the caller and the Power-Down Cycle is initiated wherein after a predetermined time interval the power is throttled down till it reaches an optimal power state.

26. A method for power management according to claim 23 comprising building a standardized client profile of the client applications to identify the CPU speed and peripheral requirements such that when the same application is required in a subsequent occasion, the power management is activated accordingly pro-actively based on the standardized client profile without any additional instructions.

27. A method for power management according to claim 23 comprising communicating with said virtual machine modules using a virtual machine system manager means and with other peripheral devices using a virtual machine hardware abstraction layer such that only when the services of a particular sub-system is required the same is activated and when the services of the sub-system is not required it is restored to an idle/sleep state.

28. A method for power management according to claim 23 comprising monitoring the processor usage requirement and throttling the processor speed accordingly.

29. A method for power management according to claim 23 comprising managing power using a concurrent state machine adapted to run independently of the main threads of the application such that when an application issues calls to an API, the state machine starts the power-up cycle and after a predefined interval the processing power of the CPU is throttled to move to a first state and subsequently the processing power is throttled further up as long as the API is executing till the virtual machine reaches the highest power state and when the API completes executing the control it is transferred back to the caller and a power down cycle is initiated.

30. A method for power management according to claim 29 wherein in said power down cycle after a predefined interval the power is throttled down till it reaches the optimal power state.

31. A method for power management according to claim 29 wherein when a new API is called during the power down cycle the power down cycle is suspended and the power up cycle is started from the last power down cycle.

32. A system for power management of computers and other mobile devices comprising:
means to initially bringing the central processing unit and all other peripheral devices to an optimal power usage state constituting an idle state;
means to identify whether the client application is about to execute a CPU intensive operation and, if so, adapted to boost the CPU speed using dynamic frequency management;
means to ascertain whether the client application is required to execute any command to activate the peripheral hardware or applications and, if so, means to power/wake up the peripheral devices from its idle state such as to enable executing of the command;
means adapted such that after the completion of execution of the command initiating a Power-Down cycle whereby the power is throttled down till it reaches the said most optimal power usage state; and
a virtual machine adapted for carrying out such power management by communicating with key modules seamlessly.

33. A system for power management according to claim 32 wherein after the boosting the power/wake up of the peripheral hardware or application the same is adapted to be maintained in the state for a desired wait period before switching to state the most optimal usage state to facilitate maintaining the overall responsiveness of the system.

34. A system for power management according to claim 32 comprising means adapted to build a standardized client profile of the client applications to identify the CPU speed and peripheral requirements such that when the same application is required to be repeated, the power management is activated accordingly pro actively based on the standardized client profile without any additional instructions.

35. A system for power management according to claim 32 comprising means for communicating with said virtual machine modules using a virtual machine system manager means and with other peripheral devices using a virtual machine hardware abstraction layer such that only when the services of a particular sub-system is required the same is activated and when the services of the sub-system is not required it is restored to an idle/sleep state.

36. A system for power management according to claim 32 comprising means adapted for monitoring the processor usage requirement and throttling the processor speed and power supply accordingly.

37. A system for power management according to claim 32 comprising means for managing power comprising a concurrent state machine means adapted to run independently of the main threads of the application such that when an application issues calls to an API, the state machine means starts the power-up cycle and after a predefined interval the processing power of the CPU is throttled to move to a first state and subsequently the processing power is throttled further up as long as the API is executing till the virtual machine reaches the highest power state and when the API completes executing the control it is transferred back to the caller and a power down cycle is initiated.

38. A system for power management according to claim 37 wherein in said power down cycle after a predefined interval the power is throttled down till it reaches the optimal power state.

39. A system for power management according to claim 37 adapted with means such that when a new API is called during the power down cycle the power down cycle is suspended and the power up cycle is started from the last power down cycle.

40. A system for power management according to claim 32 comprising:
a power manager unit operatively communicating with said virtual machine system manager, virtual machine modules for said virtual machine applications and also to the peripheral device hardware through a hardware abstraction layer.
